(19) United States
(12) Patent Application Publication
(10) Pub. No.: US 2005/0150331 A1
(43) Pub. Date: Jul. 14, 2005

(54) Removal of damaged fasteners

(76) Inventor: Bill R. Horobec, Tampa, FL (US)

Correspondence Address: LARSON AND LARSON, 11199 69TH STREET NORTH, LARGO, FL, 33773, US

(21) Appl. No.: 10/756,788

(22) Filed: Jan. 14, 2004

(51) Int. Cl. B25B 13/50

(52) U.S. Cl. 81/53.2

(57) ABSTRACT

An improved device for the removing of damaged fasteners comprising a socket head having a partly cylindrical external configuration the upper end adapted to receive the end of a turning tool. The major recess has an interior surface formed with a plurality of inverted L-shaped frustroconical projections and depending on the need the location of the apex of the teeth can be altered to create more torque. The angle of each tooth is currently 98 and 105 degrees with a recess at the bottom of each leg. Each tooth has two faces of uncommon lengths. The apex of each tooth is angularly oriented with respect to the axis of the cylinder. The axial interior of the major recess has a smaller diameter than the axial exterior of the major recess whereby when the socket head is rotated with a ratchet motion, the teeth will pull downwardly over the damaged fastener and bite into its exterior surface of the fastener to effect its removal.

### BACKGROUND OF THE INVENTION

1. Field of the Invention

The present invention relates to a tool for the removal of damaged fasteners such as nuts, bolts and studs and more particularly pertains to removing damaged fasteners wherein the heads have been damaged or rounded off as through the use of sockets or wrenches having teeth capable of biting into such heads and easy removal of the damaged fastener from the tool.

2. Description of the Prior Art

The use of socket heads for removing damaged fasteners and techniques for facilitating such removal when the heads are rounded off as is known in the prior art. More specifically, socket heads for removing damaged fasteners and techniques for facilitating such removal when the heads are rounded off heretofore devised and utilized for the purpose of removing fasteners when the heads thereof have become rounded off are known to consist of the familiar, expected and obvious structural configurations, notwithstanding the myriad of designs encompassed by the crowded prior art which have been developed for the fulfillment of countless objectives and requirements.

By way of example, the prior art discloses in U.S. Pat. No. 5,123,310 to McManus a socket for turning fastener heads having deformed head surfaces.

U.S. Pat. No. 4,607,547 to Martus discloses a stripped hex head drive socket.

U.S. Pat. No. 4,084,454 to Day discloses a socket head tool.

U.S. Pat. No. 4,063,472 to MacIntyre discloses a removable actuatable device for rotary knobs.

U.S. Pat. No. 3,847,042 to Wilson discloses a hand star wrench.

U.S. Pat. No. 5,551,320 to Horobec discloses a socket with V-shaped teeth spiraled in a tapered cylinder. Both sides of the V are essentially equal length and angle.

Lastly, U.S. Pat. No. 3,996,819 to King discloses a socket wrench attachment similar to applicant's invention but lacks the integral teeth, the working side of teeth faces are essentially angled and tapered and the pass through hole for stud removal.

In this respect, the tool for the removal of damaged fasteners such as nuts, bolts and studs according to the present invention substantially departs from the conventional concepts and designs of the prior art, and in so doing provides an apparatus primarily developed for the purpose of removing damaged fasteners wherein the heads have been rounded off through the use of sockets having teeth capable of biting into such heads and damaged fasteners from long threaded studs in addition to easy removal of the damaged fastener from the tool.

Therefore, it can be appreciated that there exists a continuing need for new and improved tool for the removing of damaged fasteners such as nuts, fasteners and studs which can be used for removing damaged fasteners wherein the heads have been rounded off as through the use of sockets having teeth capable of biting into such heads. In this regard, the present invention substantially fulfills this need.

### SUMMARY OF THE INVENTION

In view of the foregoing disadvantages inherent in the known types of socket heads for removing damaged fasteners and techniques for facilitating such removal when the heads are rounded off now present in the prior art, the present invention provides an improved tool for the removing of damaged fasteners, such as nuts, bolts and studs and nuts or fasteners from long threaded studs. As such, the general purpose of the present invention, which will be described subsequently in greater detail, is to provide a new and improved tool for the removing of damaged fasteners, such as nuts, bolts and studs apparatus and method which has all the advantages of the prior art arid none of the disadvantages.

To attain this, the present invention essentially comprises a new and improved tool for the removing of damaged fasteners with rounded off heads from nuts comprising, in combination, a socket head having a partly cylindrical external configuration with an upper end and a lower end. The upper end has several flat projections which extend beyond the cylindrical body which allow it to receive a verity of socket or wrench configurations. The top of the upper end has a square recess adapted to receive the end of a driver or ratchet wrench. The lower end of the tools head is fabricated with a major recess of a generally frustroconical configuration with a length constituting 50 percent or less of the overall body length. The major recess has an interior surface formed with a plurality of inverted V-shaped projections and the right leg of the inverted V-shaped projections is at a slight angle or almost parallel and have a radius at the base of both legs and the point of these inverted V-shaped projections gradually flatten out from midway of the major recess to the major recess smaller diameter and these projections are integral with the socket and extending radially inwardly from the lower end with valleys intermediate the inverted V-shaped projections, thereby forming a plurality of angles with radially interior teeth. Each of the angles has an apex with two faces. The face of each angle is offset from the radius of the cylinder. The apex of each tooth is angularly oriented with respect to the axis of the cylinder. The axial interior of the major recess has a smaller diameter than the axial exterior of the major recess. The major recess continues through the socket head beyond the projections into and through the square drive at the upper end whereby when placed over the head of a damaged of a fastener, the socket head is rotated with a ratchet motion. The teeth will pull downwardly over and into the damaged fastener biting into its exterior surface to effect a coupling therebetween for rotation of the socket head and associated fastener to effect its removal. The damaged fastener can be easily removed from this tool.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved tool for the removing of damaged fasteners, such as nuts, bolts and studs which has all the advantages of the prior art socket heads for removing fasteners and techniques for facilitating such removal when the heads are damaged or rounded off and none of the disadvantages.

It is another object of the present invention to provide a new and improved tool with much greater gripping ability for the removal of damaged fasteners such as nuts, bolts and studs which may be easily and efficiently manufactured and marketed and removal of the damaged fastener from the tool.

It is a further object of the present invention to provide a new and improved tool for the removing of damaged fasteners such as nuts, bolts and studs which is of a durable and reliable construction and removal of the damaged fastener from the tool.

An even further object of the present invention is to provide a new and improved tool for the removing of damaged fasteners such as nuts, bolts and studs and removal of the damaged fastener from the tool, all of which is susceptible to low cost of manufacturing with regard to both materials and labor, and which accordingly is then susceptible of low prices of sale to the consuming public, thereby making such a tool for removing damaged fasteners and techniques for facilitating such removal when the heads are rounded off economically available to the buying public.

Still yet another object of the present invention is to provide a new and improved tool for the removing of damaged fasteners such as nuts, bolts and studs which provides in the apparatuses and methods of the prior art some of the advantages thereof, while simultaneously overcoming some of the disadvantages normally associated therewith.

Still another object of the present invention is to remove damaged fasteners wherein the heads have been deteriorated from rust or rounded off as through the use of an improper sized socket having teeth capable of gripping such heads.

Lastly, it is an object of the present invention to provide a new and improved device for the removal of damaged fasteners with rusted or rounded off heads. The socket head has a partly cylindrical external configuration with an upper end arid a lower end and with a square recessed surface in the upper end and is adaptive to receive the end of a turning tool. The lower end of the socket head is fabricated with a major recess of a generally frustroconical configuration. The major recess has an interior surface formed with a plurality of inverted V-shaped projections and the right leg of the inverted V-shaped projections is at a slight angle or almost parallel and these projections are integral with the socket and extending radially inwardly from the lower end thereby forming a plurality of angles with radially interior teeth. Each of the angles has an apex with two faces. The faces of each angle are offset from the radius of the cylinder. The apex of each tooth is angularly oriented with respect to the axis of the cylinder. The axial interior of the major recess has a smaller diameter than the axial exterior of the major recess whereby when placed over the damaged fastener and when the socket head is rotated with a ratchet motion, the teeth will pull downwardly over the damaged fastener and bite into its exterior surface to effect a coupling therebetween for rotation of the socket head and associated damaged fastener to effect its removal. The damaged fastener can easily be removed by tapping it out from the side with the square recess.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a sectional side view of the tool and a bottom view.

FIG. 2 is an exploded perspective view of the tool and a open ended wrench and associated damaged fastener to be removed.

FIG. 3 is a closed end wrench design for removing a damaged fastener.

FIG. 4 is a pass through ratchet design for removing a damaged fastener on a long stud.

Similar reference characters refer to similar parts throughout the several views of the drawings.

### DESCRIPTION OF THE PREFERRED EMBODIMENT

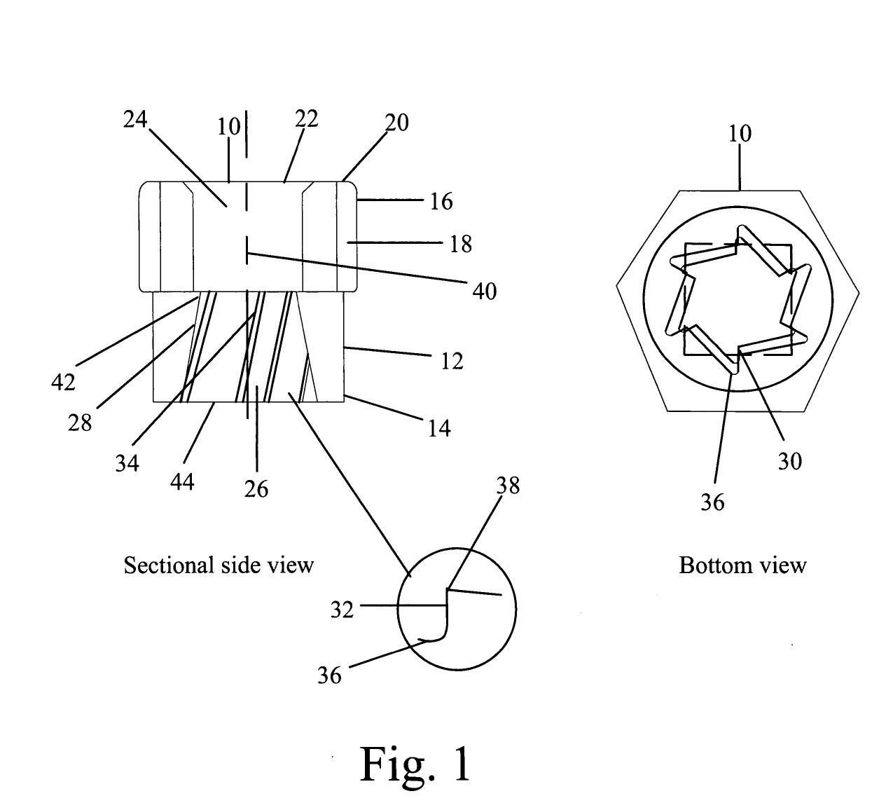

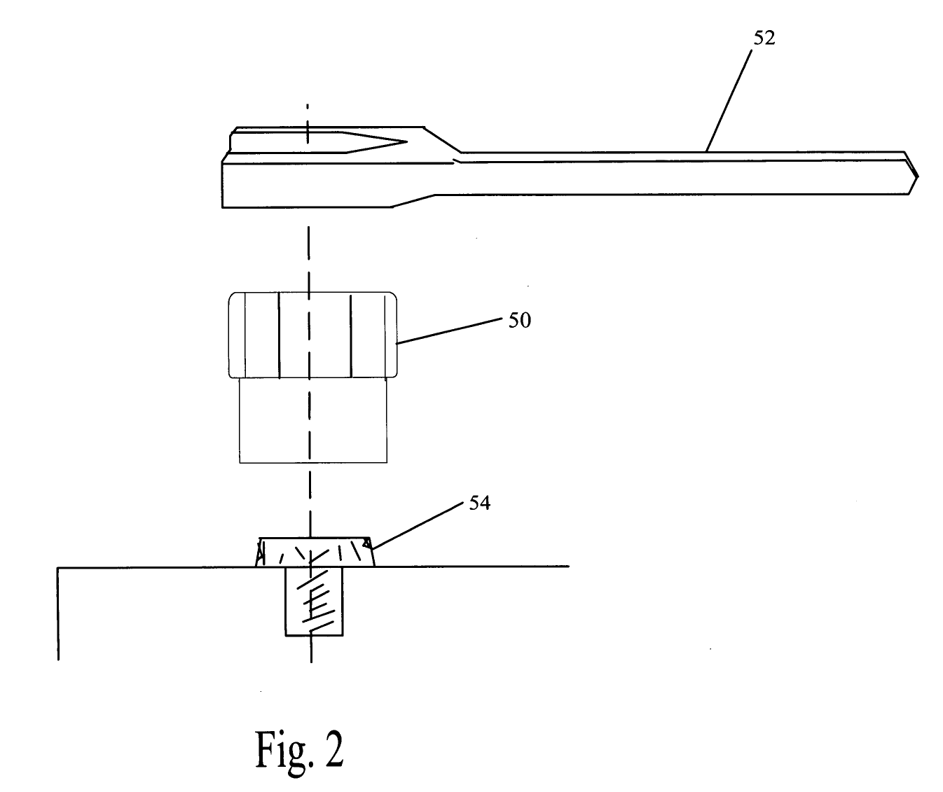

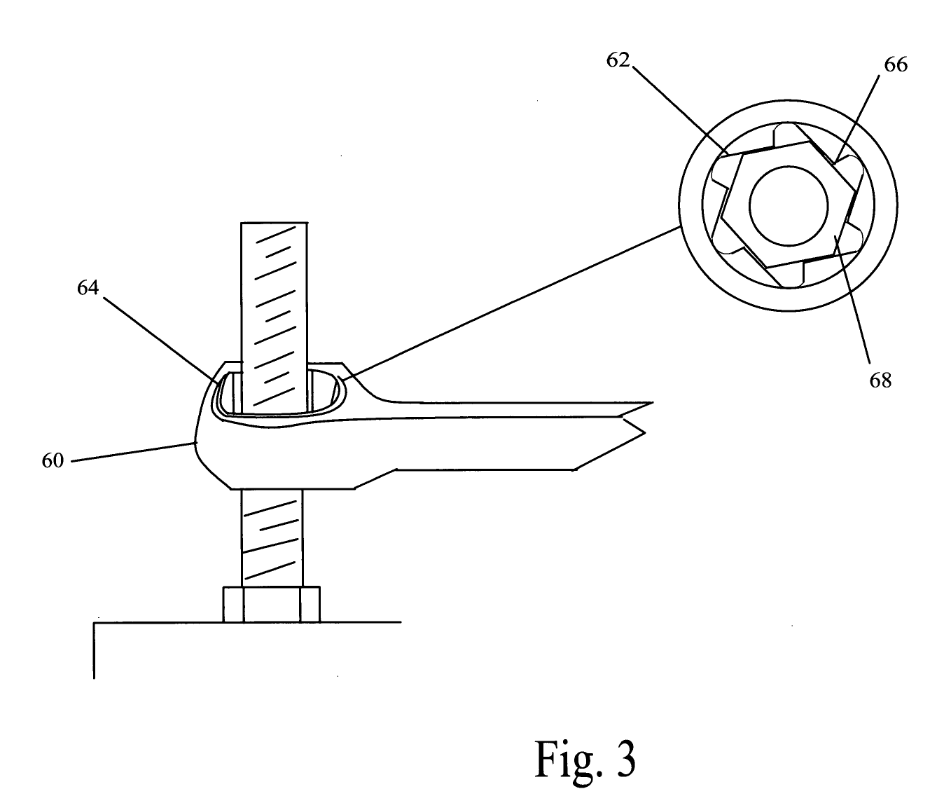

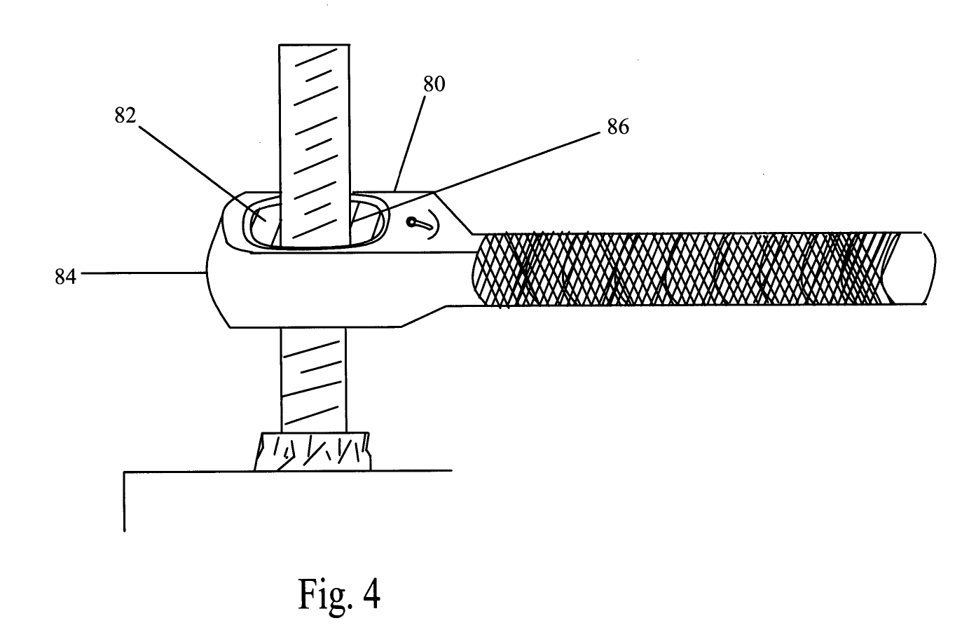

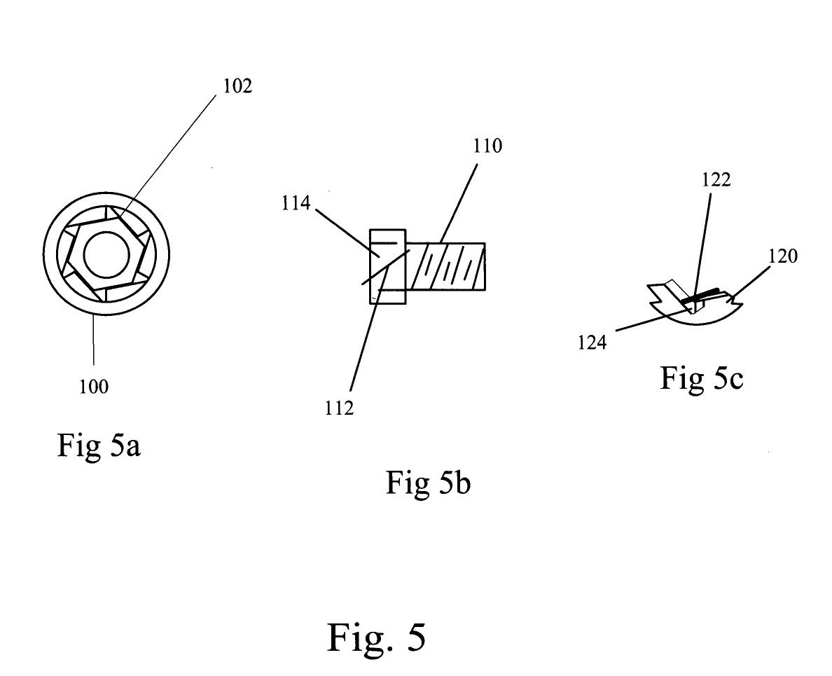

With reference now to the drawings, and in particular to FIG. 1 thereof, a new and improved tool for the removing of damaged fasteners such as nuts, bolts and studs embodying the principles and concepts of the present invention and generally designated by the reference numeral 10 will be described.

The present invention, the new and improved tool i or the removal of damaged fasteners such as nuts. bolts and studs, which comprise of a plurality of tools sizes. Such components for each tool are individually configured and correlated with respect to each other so as to attain the desired objective.

More specifically, the present invention is a tool 10 of different sizes for functioning with a different size damaged fasteners to be removed. Each tool is formed of a partly cylindrical exterior configuration 12 at the lower end 14. The upper end 16 sides of the exterior have multiple parallel flats 18 that extend horizontally beyond the cylindrical lower end which allow for application of a wrench or socket in the removal process. The top 20 of upper end has a square recess 22 that continues partly into the tools interior 24. This square recess 22 is adapted to receive the end of a ratchet wrench or square driving devise in the conventional manner.

The lower end interior 14 of each socket head is fabricated with a recess 26. Such recess is of a generally frustroconical configuration 28. Such configuration includes a plurality of inverted V-shaped projections 30 and the right leg of the inverted V-shaped projections is at a slight angle or almost parallel 32 and extending radially inwardly 34. Intermediate therebetween, the inverted V-shaped projections are a plurality of angles and radius bases 36 all of which create radially interior teeth. The edge 38 of each tooth is angularity oriented with respect to the axis 40 of the cylinder.

The axial interior 42 of the recess has a smaller diameter than the axial exterior 44 of the recess. In this manner, when placed over a damaged fastener, stud or nut, and rotated with a ratchet motion, the teeth pull the invention downwardly over the head of the fastener and bite into its exterior surface. This will effect a coupling between the socket head and the fastener. Rotation of the cylindrical member of the socket head and coupled fastener will function to effect the removal of the fastener. This design also provides easy removal of the damaged fastener.

The present invention thus relates to apparatus for the removing of damaged fasteners such as studs or fasteners with rounded off interior and or exterior heads. The apparatus comprises, in combination, a socket head having a partly cylindrical external configuration with an upper end and a lower end and an axis with a first axial length therebetween. The socket also has a square recess on the upper end adapted to receive the end of a ratchet wrench. It also preferably has flat regions 18 in its exterior surface, either 2, 4, 6, 8, etc, for receiving a wrench or ratchet or other turning tools. The lower end of the socket head is fabricated with a major recess of a generally frustroconical configuration.

The major recess has an interior surface formed with a plurality of inverted V-shaped projections and the right leg of the inverted V-shaped projections is at a slight angle or almost parallel integral with the socket and extending radially inwardly from the lower end. Fabricating the teeth integral with the socket head decreases the cost of fabrication as compared with separable teeth as exemplified by king while increasing the efficiency during use. The formation of the inverted V-shaped projections and the right leg of the inverted V-shaped projections is at a slight angle or almost parallel. The teeth integral with the socket head is different from King and the rest of the prior art and reduces costs significantly with increasing efficiency in the use of the present invention. The slight angle or almost parallel right leg creates much greater torque as the tool bites into the damaged fastener and yet allows for easy removal then the Horobec or King tool. The projections include radiuses valleys intermediate the right leg of the inverted V-shaped projections is at a slight angle or almost parallel. The projections and valleys thereby form a plurality of angles with radially interior teeth. Each of the angles has an apex with two faces of uncommon lengths. The faces of each angle are offset from the radius of the cylinder. The apex of each tooth is angularity oriented with respect to the axis of the cylinder. This arrangement of teeth allows tightening and pulling down around the work-piece and biting into the surface of a damaged fastener, when turned in one direction while allowing release when counter rotated. This is significantly different from the prior art as exemplified by King where the work-piece must be beaten out of the socket. The axial interior of the major recess has a smaller diameter than the axial exterior of the major recess. The major recess continues through the socket head beyond the projections with a width greater than the diameter of the major recess at its axial interior. In this manner, when the socket is placed over a rounded off head of a damaged fastener, a portion thereof may extend beyond the projections. The prior art as exemplified by King has no such enlarged hole greater than the smallest diameter of the lower portion of the socket, and, consequently, the prior art devices cannot remove nuts on elongated studs. Further, when the socket head is rotated with a ratchet motion as in the present invention. the teeth will pull downwardly over the damaged fastener and bite into its exterior surface to effect a coupling therebetween. This allows; for rotation of the socket head and associated damaged fastener to effect its removal.

The present invention is a tool for removing fasteners, studs and nuts with damaged heads. Frequently, when installing or trying to remove a fastener, stud or nut, a mechanic may chew up or round off its head, making it difficult to grab hold of the head with a conventional wrench or other tools. Studs become rusty and threads worn. Other tools might have the capability of removing the damaged fastener, but once the fastener is, removed it can't be removed from the tool easily if at all. The present invention pulls down to the base of the damaged fastener with a much greater force and the design of the angles on each leg, allows for easy removal of the damaged fastener from the tool. Also, it may be difficult to get to the damaged fastener due to a precarious location or limited amount of space. The present invention was conceived and a prototype was fabricated by the inventor to address all these problems.

The present invention is a set of sockets that fit onto standard ratchets. They are made of hardened tool steel and could be sold in many sizes. The socket of the tool has very sharp teeth that surround its inner surface.

To remove a fastener, stud or nut with a damaged head, the mechanic attaches the proper size fastener remover to the ratchet wrench, places the socket over the damaged fastener and tighten the ratchet, thus drawing the sharp teeth tighter into the damaged fastener. The damaged fastener remover pulls itself down on the damaged fastener, stud or nut, enabling the tool to grab the head securely and remove the damaged fastener. Also, the tool is able to reach hard to get at places by using different ratchet fittings and universal joints. For long studs the fastener remover would pull the stud until it reaches the base of the stud then it will bind and remove the stud.

The present invention makes it much easier to remove damaged fasteners with rounded off heads. It is a very practical and time saving tool for professional and amateur mechanics.

As to the manner of usage and operation of the present invention, the same should be apparent from the above description. Accordingly, no further discussion relating to the manner of usage and operation will be provided.

With respect to the above description then, it is to be realized that the optimum dimensional relationships from the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. (canceled)

2. (canceled)

3. (canceled)

4. (canceled)

5. This same inverted L-shaped design with no helix and taper and by moving the inverted L-shape point to the center of the damaged or undamaged fastener will create greater torque.

6. A new and improved tool for the removal of both metric and standard damaged fasteners, in combination:
a socket head having a cylindrical external configuration with an upper end and a lower end and an axis with a first axial length therebetween and the lower end of the socket head being fabricated with a major recess of a generally frustroconical configuration, the major recess having an interior surface formed with a plurality of inverted L-shaped projections and the angle of each tooth is 98 degrees and 105 degrees with a recess at the bottom of each leg which connects the inverted L-shaped projections and are integral with the socket and extending radially inwardly from the lower end, thereby forming a plurality of angles with radially interior teeth, each of the angles having an apex with two faces of uncommon lengths, the faces of each angle being offset from the radius of the cylinder, the apex of each tooth being angularly oriented with respect to the axis of the cylinder, the axial interior of the major recess having a smaller diameter than the axial exterior of the major recess, whereby when placed over a rounded off head of a damaged fastener, and the socket head is rotated with a ratchet motion, the teeth will pull downwardly over the damaged fastener and bite into its exterior surface to effect a coupling therebetween and effect its removal.

7. A device for the removal of both metric and standard undamaged fasteners comprising:
a socket head having all the data in claim 1 in addition this tool will accept an undamaged fastener, whereby the apex of each tooth on the tool lands behind the fasteners points, in addition because each tooth is on a helix, each tooth has a greater landing area onto the fastener and the hexagon design continues the length of the interiors helix to effect a coupling there between for rotation of the socket head and associated fastener to effect its removal.

8. The device as set forth in claim 1 and 2 wherein the intersection of flats on the head of the bolt or nut forms a point which is covered by the recess between each tooth when the tool is placed over an undamaged fastener.

9. This same inverted L-shaped design can also be used for installation and removal of undamaged and damaged fasteners and the teeth are designed with helix and taper and the apex of each tooth falls in the midpoint of the fastener when implemented into specific wrenches or a ratchet.
